(19) United States
(12) Patent Application Publication
(10) Pub. No.: US 2017/0035024 A1
(43) Pub. Date: Feb. 9, 2017

(54) SPIRAL SLIDE PET TOY AND TREAT DISPENSER

(71) Applicants: Michael Parness, Foxfield, CO (US); Kyle Hansen, Castle Rock, CO (US)

(72) Inventors: Michael Parness, Foxfield, CO (US); Kyle Hansen, Castle Rock, CO (US)

(21) Appl. No.: 14/817,058

(22) Filed: Aug. 3, 2015

(51) Int. Cl. A01K 5/02; A01K 15/02

(52) U.S. Cl. CPC A01K 5/0233; A01K 15/025

(57) ABSTRACT

The invention relates to a novel pet toy and treat dispenser wherein treats are inserted into a hollow center tube and a cap is placed to close the fill tube. A basket with a hole for a ball drop resides atop the fill tube. A ball must then be dropped into the basket where it will travel down a spiral track and fall onto a trip tab which will briefly open a flap and a few treats will be ejected into a dish portion in the base. The flap will then reclose in preparation for further activation.

### FIELD

The invention relates to a novel pet toy and treat dispenser wherein treats are inserted into a hollow center tube and a cap is placed to close the fill tube. A basket with a hole for a ball drop resides atop the fill tube. A ball must then be dropped into the basket where it will travel down a spiral track and fall onto a trip tab which will briefly open a flap and a few treats will be ejected into a dish portion in the base. The flap will then reclose in preparation for further activation. This toy can also be modified to include sound or motion activated treat release.

### BACKGROUND OF THE INVENTION

The invention most closely corresponds with USPTO Class 119/51.01 wherein Class 119 relates to animal husbandry and sub-class 51.01 includes feeding devices.

In its simplest form, the invention relates to a novel pet toy and treat dispenser wherein inserted treats are released after a ball activates a release flap at the base of the toy and treats are then ejected into a tray in the base piece.

The toy and treat dispenser has an open topped basket top piece wherein access to a hollow center tube for filling and an offset aperture for a ball drop are contained therein.

A fill cap is located at the top of the hollow center tube and is replaced after treats are poured into the tube. Once the toy is filled a ball is dropped by a pet into the basket and via gravity will travel through an opening and onto the spiral rail which guides the ball to the base piece.

### SUMMARY, OBJECTS AND ADVANTAGES

On the base piece, a trip tab keeps inserted treats in the center tube until compression by the ball allows the tab to move briefly and treats are then ejected into a tray on the base piece. The trip tab then returns to a resting state and is ready for another triggering event.

It well known that dogs do experience a sense of boredom, and if not addressed, may manifest in negative behavior such as chewing furniture or going to the bathroom in undesirable locations in the pet owner's home. It is also known that most dogs will consume whatever food is in front of them, and typically too quickly. The inventive toy and dispenser delays consumption and aides in controlling amount thereof.

The inventive toy and treat dispenser addresses not only the dog's curiosity and huger sensations, it requires the dog to exhibit learned behavior. The dog must learn that to obtain a treat kibble it must do so by dropping the ball into the top basket. The spiraling effect of the ball triggers interest as well as a learned behavior response when treats are ejected out of the base.

Similar to Alzheimer's disease in humans, Canine Cognitive Dysfunction manifests in dogs primarily affecting memory, learning and comprehension. As with humans, there are exercises that are said to help stimulate and thus help avoid this dysfunction. Most certainly, entertained and challenged dogs are more alert and content than those who are not stimulated sufficiently.

The inventive toy and treat dispenser provides stimulation to the dog's sense of smell, visual acuity, and the reward acknowledgement. The dog can smell and see the kibble within the dispenser toy, and is stimulated by the ball rolling down the spiral track.

The dog learns that unless it places the ball in the basket piece, no kibble will dispense. This behavior model will require attention and retention behaviors of the pet. The reward of treats or kibble encourages the pet to reengage with the toy and dispenser. Another embodiment includes the use of motion or sound activated treat release.

### BRIEF DESCRIPTION OF THE DRAWINGS

The invention is described in further detail by reference to five (5) drawings sufficient in detail to describe the invention in which:

FIG. 1 shows a dog dropping a ball into the basket;

FIG. 2 illustrates the balls movement down the spiral rail;

FIG. 3 displays the tab release and dog consuming kibble;

FIG. 4 is a clear view of the dispenser's exit aperture for kibble ejection, and

FIG. 5 is a top perspective showing the fill cap and internal basket configuration.

### DETAILED DESCRIPTION, INCLUDING BEST MODES OF CARRYING OUT THE INVENTION

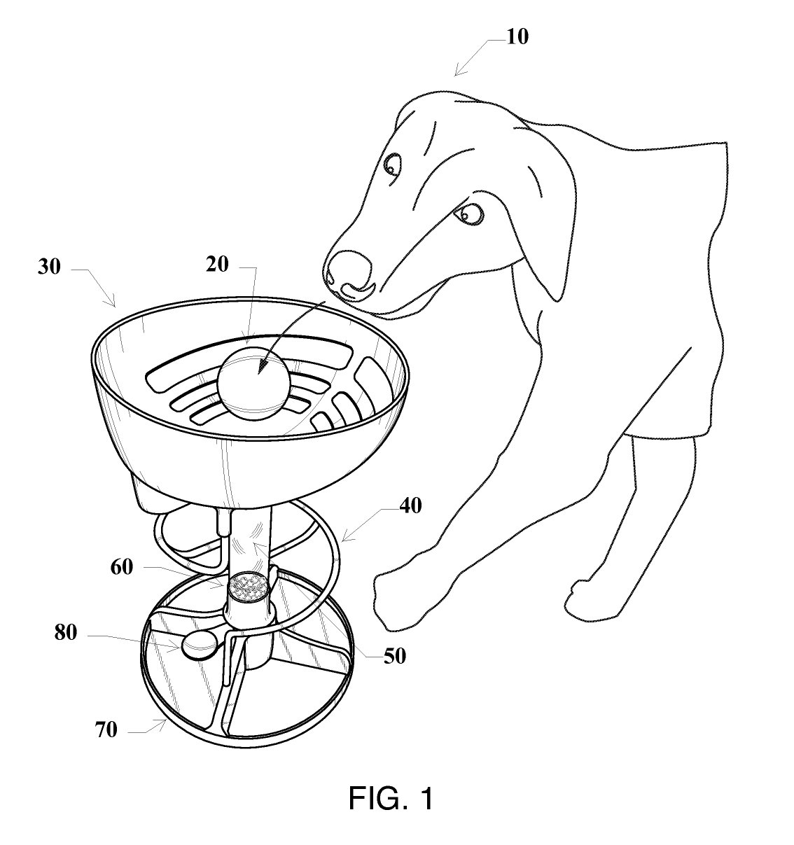

FIG. 1 illustrates the spiral slide pet toy and treat dispenser. Obviously a dog 10 is dropping a ball 20 into the open top basket 30. Also illustrated in this Figure are the spiral rail 40 in which the ball will roll down after being dropped by the dog. A bit of kibble 60 is seen through the transparent center tube 50 wherein a user has filled the dispenser. Also shown in this Figure are the base piece 70 and the release tab 80.

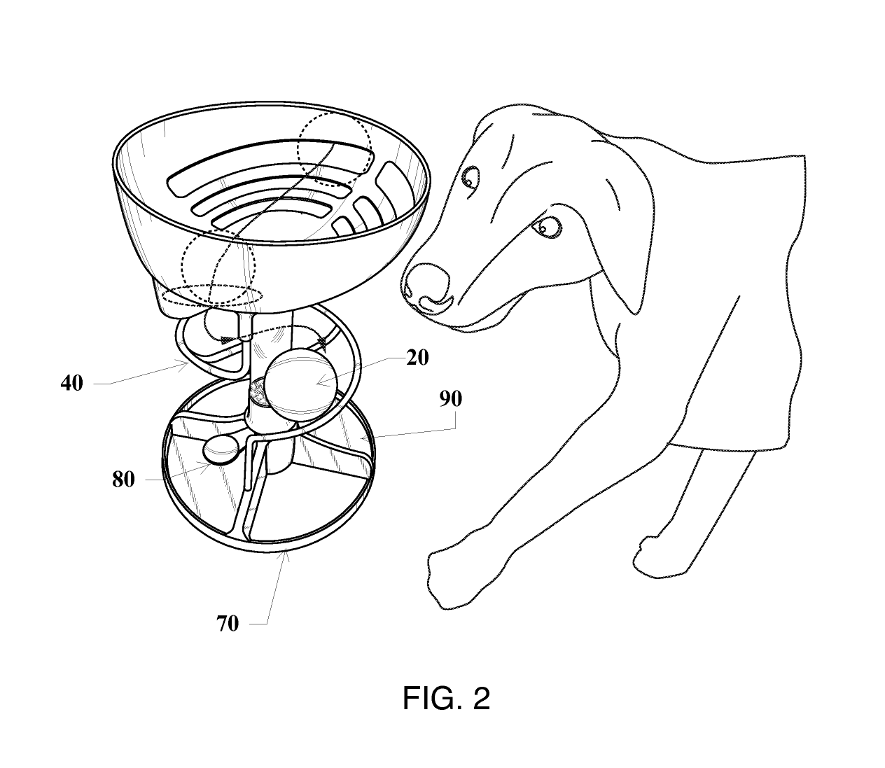

FIG. 2 shows the ball 20 as it travels down the spiral rail 40. It should be noted that the base piece 70 contains a tray 90 opposite the release tab 80. When the toy is activated and kibble ejects, it will fall into this tray for consumption.

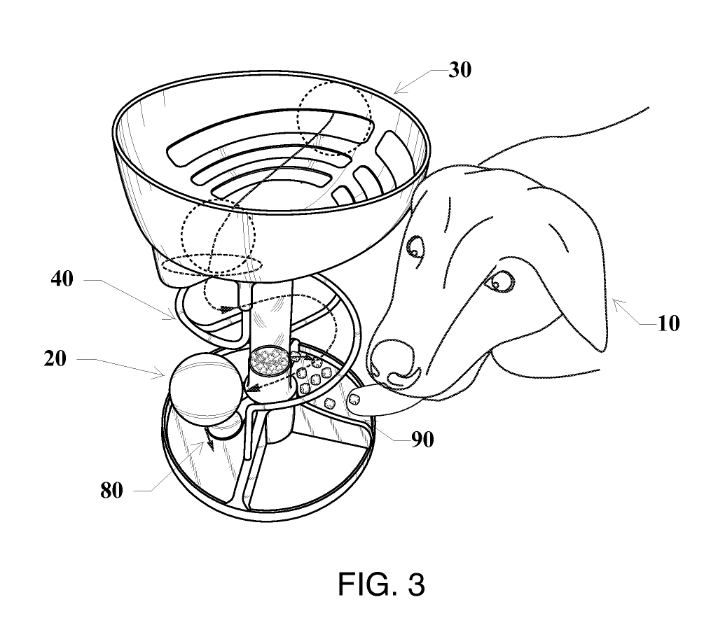

FIG. 3 is a simple representation of the toy and dispenser fully activated. The ball 20 has rolled down the spiral rail 40 and triggered the release tab 80. Unseen is an opening the depressed tab creates which allows a few kibble to be released into the tray 90. The dog 10 happily consumes the released treats. Since the release tab is not large enough to retain the ball, it will logically roll off and the dog must learn to reactivate the entire process by retrieving the ball and dropping it again into the top basket 30.

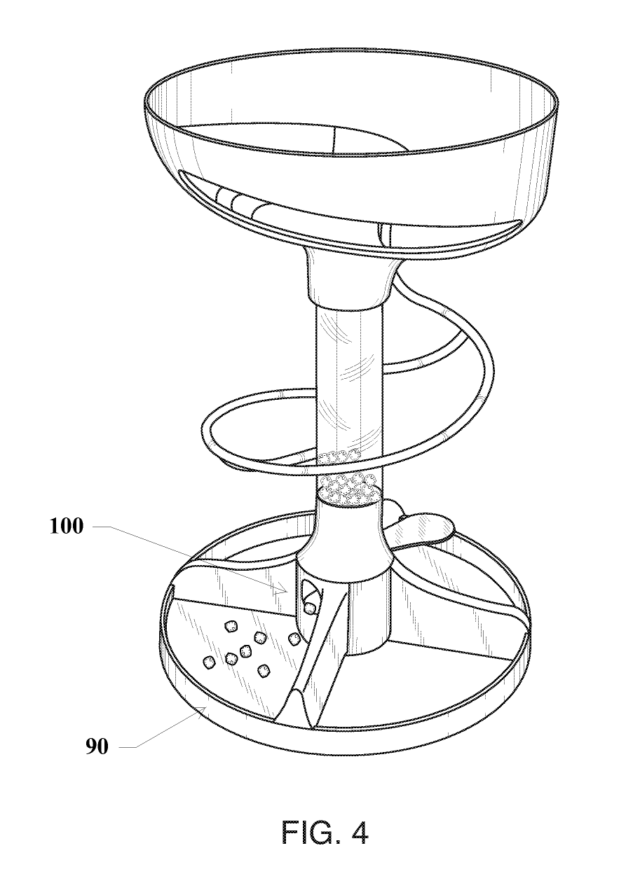

FIG. 4 is an unobstructed view of the exit aperture 100 to illustrate how food kibble ejects. Assume for this example that the trip tab has been depressed and kibble ejects into the tray 90. Not shown in this Figure is an embodiment that includes motion or sound triggered treat release wherein a small electronic component can trip the tab and release treats.

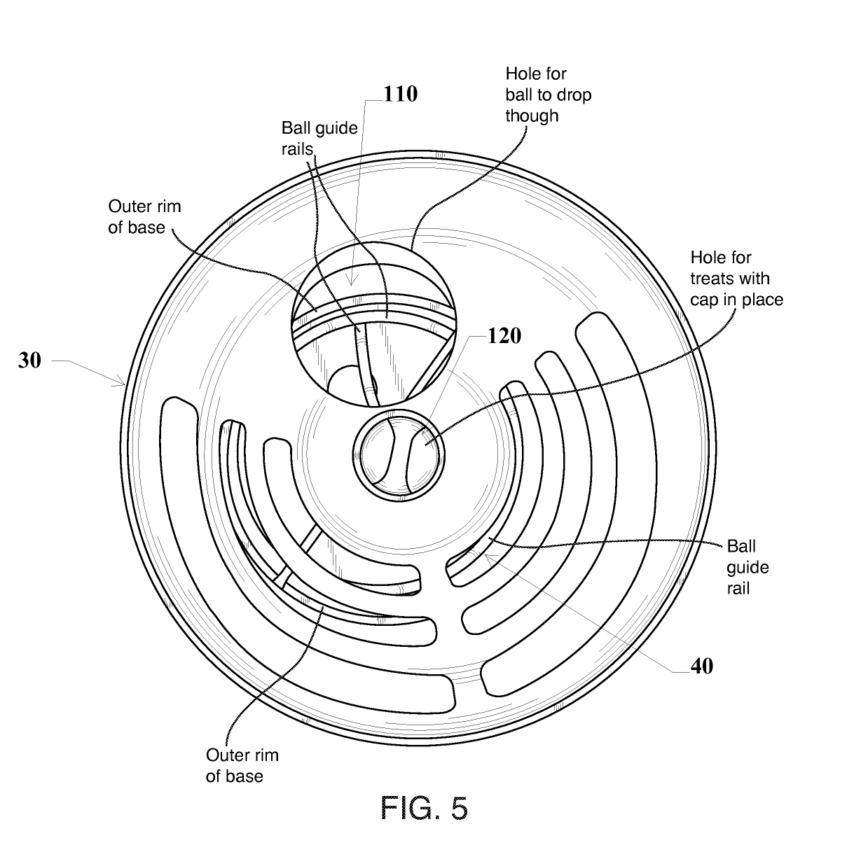

FIG. 5 is a top perspective of the basket portion 30. The spiral slide rail 40 can be seen through the basket. An offset hole 110 allows a dropped ball to fall onto the top of the spiral slide rail and begin its trajectory downward. A fill cap 120 is located at the top of the center tube 50 as in FIG. 1 which allows a User to fill the tube with kibble. This view clearly illustrates the mechanisms through which the toy is activated by the ball.

1) A spiral slide pet toy and treat dispenser comprising:
a) a base piece with inset tray portion
b) a hollow center tube for filling with treats
c) a threaded filling aperture with cap
d) an open top basket piece
e) a spiral slide track
f) a trip tab on the base piece
g) an exit aperture for treats.

2) The spiral slide pet toy and treat dispenser as in claim 1 wherein a molded plastic base piece is connected to the hollow center tube and has a tray portion for ejected treats to reside in.

3) The spiral slide pet toy and treat dispenser as in claim 1 wherein a hollow plastic tube is connected to the base piece and will hold user inserted treats.

4) The spiral slide pet toy and treat dispenser as in claim 1 wherein the hollow center tube connected to the base piece contains a threaded opening for filling and a cap which is removed and replaced thereafter by screwing the cap onto the threaded opening.

5) The spiral slide pet toy and treat dispenser as in claim 1 wherein an open topped basket is connected to the hollow center tube and allows space for receiving a ball and for the filling aperture, and wherein the basket has an offset opening for a ball to drop through.

6) The spiral slide pet toy and treat dispenser as in claim 1 wherein a plastic spiral track encircles the center tube and is connected to the top basket and the base piece and allows a dropped ball to travel in a spiral trajectory from the basket to the base piece.

7) The spiral slide pet toy and treat dispenser as in claim 1 wherein a plastic trip tab uncovers the treat exit aperture when it is depressed by a dropped ball and will allow a few treats to be ejected into the tray portion of the base piece.
